(19) United States
(12) Patent Application Publication
(10) Pub. No.: US 2010/0288384 A1
(43) Pub. Date: Nov. 18, 2010

(54) HYDRAULIC CONTROL VALVE HAVING INTEGRATED CHECK VALVE

(76) Inventors: Jens Hoppe, Erlangen (DE); Ali Bayrakdar, Roethenbach/Pegnitz (DE)

Correspondence Address: LUCAS & MERCANTI, LLP, 475 Park Avenue South, New York, NY, 10016, US

(21) Appl. No.: 12/863,135

(22) PCT Filed: Dec. 4, 2008
(86) PCT No.: PCT/EP08/66803

§ 371 Date: Jul. 15, 2010

(30) Foreign Application Priority Data
Jan. 16, 2008 (DE) 102008004591.8

(51) Int. Cl. F16K 15/16

(52) U.S. Cl. 137/843

(57) ABSTRACT

A hydraulic control valve for controlling pressurizing medium flows, which has a hydraulically unlockable cheek valve that includes a closing element by which a valve opening can be closed. The closing element is equipped with at least one through-hole such that a locking part that is spring-loaded via at least one flexible tongue is formed for locking the valve opening.

### FIELD OF THE INVENTION

The invention in the technical field of hydraulic fluid control relates to a control valve of generic type having an integrated check valve for controlling hydraulic fluid flows, in particular for a camshaft adjuster.

### STATE OF THE ART

In internal combustion engines gas exchange valves are actuated by cams of at least one camshaft that is made to rotate by a crankshaft. In view of the thermodynamic processes involved, it has proved advantageous to influence the port timing of the gas exchange valves during the operation of the internal combustion engine, which can be done by adjusting the rotational position of the crankshaft and the camshaft relative to one another. In modern internal combustion engines this purpose is served by devices connected to the oil circuit of the internal combustion engine for adjusting and fixing the rotational position of the camshaft and the crankshaft relative to one another, these devices generally being referred to as ‘camshaft adjusters’ for short.

Camshaft adjusters generally comprise a drive part rotationally fixed to the crankshaft by a driving gear, and an output part fixed to the camshaft, together with a hydraulic adjusting mechanism, which is connected between the drive part and the output part and which transmits the torque from the drive part to the output part and also serves for adjusting and fixing the rotational position of the drive part and the output part relative to one another.

In a common type of camshaft adjuster these are configured as so-called rotary piston adjusters, in which the drive part is embodied as outer rotor (‘stator’) and the output part as an inner rotor (‘rotor’) arranged concentrically with the outer rotor. In the radial gap between stator and rotor, pressure compartments are formed, which are each divided into two pressure chambers by dividing elements (‘vanes’) connected to the rotor, for example. By specifically pressurizing the pressure chambers it is possible to swivel the rotor hydraulically in relation to the stator, thereby turning the camshaft and consequently adjusting the rotational position of the camshaft and the crankshaft relative to one another. A hydraulic bracing of the stator and the rotor is also possible.

The camshaft adjuster is controlled by an electronic control unit, which controls the admission of hydraulic fluid to the individual pressure chambers and its discharge therefrom on the basis of registered characteristic data of the internal combustion engine. The hydraulic fluid flows are in this case controlled by a hydraulic control valve controlled by electrical signals from the control unit.

Hydraulic control valves in the form of multiway slide valves for controlling hydraulic fluid flows for camshaft adjusters are common knowledge as such. As main components they comprise a valve housing and a control piston, which is accommodated so that it is axially displaceable in a housing cavity and is actuated by an actuator, typically a solenoid having a plunger.

In one common type of control valve, these are designed as so-called central valves, which are inserted into a central bore in the output part of the camshaft adjuster fixed to the camshaft. The valve housing of such a central valve is provided with a thread, which serves for screwing the valve housing into a corresponding tapped hole in the camshaft, in order to fix the output part rotationally to the camshaft. Hydraulic fluid is admitted to the hydraulic fluid connection of the control valve or discharged from its outlet connection through the output part or the camshaft.

During operation of the internal combustion engine, alternating moments can occur on the crankshaft, which, via the pressure chambers, are transmitted to the hydraulic system of the camshaft adjuster as pressure surges. In order to prevent any propagation of such pressure surges, hydraulically openable check valves are inserted in the hydraulic fluid inlet of the camshaft adjuster. Such check valves are described in the published German patent application DE 102004038252 A1 and in the published German patent application DE 102004035035 A1, for example.

A control valve of generic type having an integrated check valve is described, for example, in the published German patent application DE 102005052481 A1 of the present applicant. In this control valve, which is embodied as a central valve, a hydraulically openable check valve, which is provided with a closing element in the form of a ball, is arranged downstream of a hydraulic fluid connection (hydraulic fluid inlet). The ball is pressed onto a valve seat by a spring element and can be lifted from its valve seat by the hydraulic fluid in opposition to the spring force.

As has emerged in practice, the relatively large mass moment of inertia of the ball means that such a check valve only shuts off the return flow of hydraulic fluid with an undesirably long time delay, which has a detrimental effect on the rate of adjustment of the camshaft adjuster.

### SUMMARY OF THE INVENTION

### Object of the Invention

In response to this, the object of the present invention is to provide a control valve having an integrated check valve for controlling hydraulic fluid flows, which will allow a more rapid rate of adjustment of the camshaft adjuster.

### Achievement of the Object

According to the invention, this and other objects are achieved by a control valve having an integrated check valve for controlling hydraulic fluid flows, in particular for a hydraulic camshaft adjuster of an internal combustion engine, having the features of the independent claim. Advantageous developments of the invention are specified by the features of the dependent claims.

According to the invention, a hydraulic control valve is shown having an integrated check valve for controlling hydraulic fluid flows, which serves in particular for controlling hydraulic fluid flows of a hydraulic camshaft adjuster.

The control valve according to the invention for controlling hydraulic fluid flows comprises a hollow valve housing having at least one inlet connection, at least two working connections and at least one outlet connection. It further comprises a control piston, which is guided so that it is axially displaceable inside the valve housing and which serves to connect the inlet connection to either working connection via at least a first hydraulic fluid line as a function of the position, that is to say according to the axial position of the control piston, while the respective other working connection is connected to the outlet connection via at least a second hydraulic fluid line.

In addition, it comprises at least one hydraulically openable check valve opening the first hydraulic fluid line in the inlet direction and having a closing element, which serves for closing a valve aperture.

A major distinguishing feature of the control valve according to the invention is that the closing element is provided with at least one perforation, such that a sealing part, resiliently supported by at least one flexible tongue, is formed for sealing of the valve aperture by the closing element. For this purpose, the closing element is of lamellar design.

In an advantageous development of the control valve according to the invention the closing element is formed from the sealing part and an outer part at least partially surrounding the sealing part, the outer part being provided with a plurality of perforations surrounding the sealing part in a (partially) spiral shape in order to form a plurality of flexible tongues.

In a further advantageous development of the control valve according to the invention the closing element is formed from the sealing part and an outer part at least partially surrounding the sealing part, the outer part being provided with a plurality of (partially) annular perforations concentrically surrounding the sealing part in order to form a plurality of flexible tongues.

In a further advantageous development of the control valve according to the invention, the closing element is of disk-shaped design.

In a further advantageous development of the control valve according to the invention, at least one perforation is of slit-shaped design and has a minimum slit width of at least 1 mm. In this case, it is preferred if at least one perforation has a minimum slit width in the order of 1 to 2 mm.

In a further advantageous development of the control valve according to the invention, the closing element is composed of spring steel. In this case it is preferred if the spring steel has a thickness in the order of 0.1 to 0.5 mm.

In a further advantageous development of the control valve according to the invention, a hollow hydraulic fluid baffle insert having a hydraulic fluid duct for the fluid-conducting connection of the inlet connection to a control groove of the control piston and accommodating the control piston so that it is axially displaceable in the hollow cavity thereof, is arranged inside the valve housing. Here, the hydraulic fluid baffle insert is provided with a structured portion for fixing the closing element to a seating face. It is advantageous here if the seating face is formed by a seating face insert inserted into the housing cavity. Equally it may be advantageous if the seating face insert is provided with a retaining element for the relative axial fixing of the hydraulic fluid baffle insert.

In an especially advantageous development, the hydraulic fluid baffle insert forms a stop for the closing element situated in the open position, in order to prevent overstretching of the flexible tongues.

The invention further extends to a hydraulic camshaft adjuster comprising a control valve as described above.

### BRIEF DESCRIPTION OF THE DRAWINGS

The invention is now explained in more detail on the basis of exemplary embodiments and with reference to the drawings attached. Identical or similarly functioning elements in the drawings are denoted by the same reference numerals. In the drawings:

FIG. 1 shows an axial sectional view of a control valve according to one exemplary embodiment of the invention;

FIG. 2 shows an enlarged detail of the control valve in FIG. 1 in the area of the check valve;

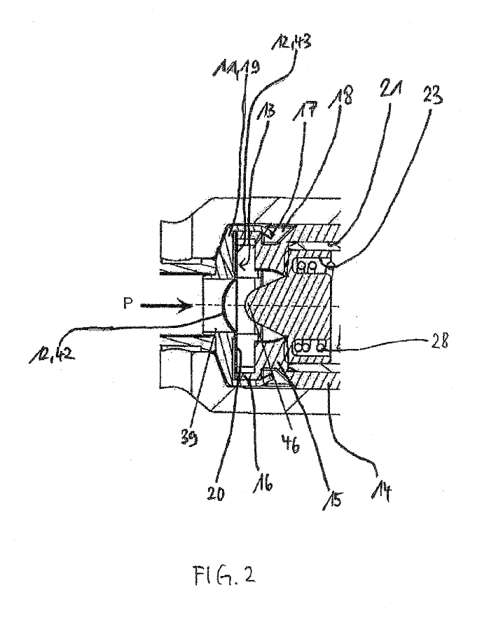

FIG. 3 shows a perspective view and an axial sectional view of one exemplary embodiment of the sealing disk of the check valve of the control valve in FIG. 1;

FIG. 4 shows a perspective view and an axial sectional view of a further exemplary embodiment of the sealing disk of the check valve of the control valve in FIG. 1;

FIG. 5 shows a perspective view and an axial sectional view of a further exemplary embodiment of the sealing disk of the check valve of the control valve in FIG. 1.

### DETAILED DESCRIPTION OF THE DRAWINGS

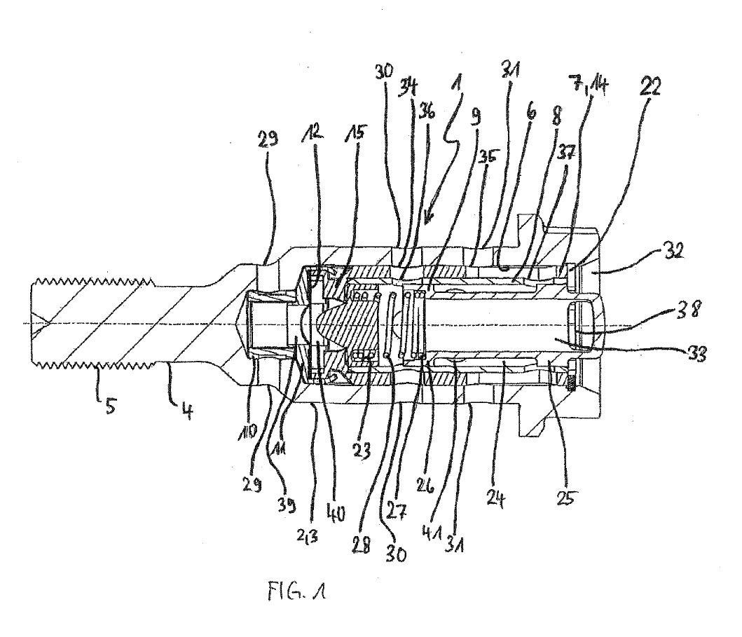

FIG. 1 shows an exemplary embodiment of the control valve according to the invention. The control valve is embodied in the form of a central valve and for use thereof can be inserted into a central bore in the output part (rotor) of a hydraulic camshaft adjuster. The placing of such a central valve in a camshaft adjuster and its attachment to the hydraulic system (oil circuit) of an internal combustion engine will as such be known to the person skilled in the art and is described in detail, for example, in the generic published patent application DE 102005052481 A1 cited in the introductory part, so that a further description here would be superfluous. With regard to the arrangement of the central valve according to the invention in a hydraulic rotary piston adjuster and its attachment to the hydraulic fluid circuit, reference is made to the disclosure of this publication in its entirety.

The control valve, denoted overall by the reference numeral 1, comprises a valve housing 2, which is embodied in the form of a central screw corresponding to the design of the control valve as a central valve.

The valve housing 2 accordingly comprises a widening, stepped housing body 3 and a housing shank 4, which is formed onto the housing body 3 in the area of the smallest body diameter and is provided with an external thread 5. The housing shank 4 may be screwed into a seating bore of a camshaft provided with a corresponding internal thread, which is not shown in FIG. 1. In the control valve 1 only the housing body 3 to be accommodated in a central bore of the output part of the camshaft adjuster serves for controlling the hydraulic fluid flows.

In the area of the housing body 3 the valve housing 2 is provided with a housing cavity 6, which is embodied in the form of a blind hole-like socket. On the housing shank side a ring filter 10, a seating face insert 11 and a sealing disk 12, which serves as closing element of a check valve, denoted overall by the reference numeral 13, and which will be explained in yet more detail below, are inserted into the housing cavity 6.

A hydraulic fluid baffle insert 7, which in its outside diameter is matched to the inside diameter of the housing cavity 6, is inserted into the housing cavity 6. The hydraulic fluid baffle insert 7 comprises a sleeve-shaped insert portion 14 having a formed-on structured portion 15 on the housing shank side, which is provided at the end face with an axial support ring 16. The support ring 16 is accommodated inside an axial retaining collar 17, which is formed on a seating face element 19 of the seating face insert 11. Here, an end face of the axial support ring 16 comes to bear against the sealing disk 12, which in turn bears against a seating face 20 formed by the seating face element 19. At its free end remote from the housing shank 4 the retaining collar 17 is curved radially inwards and grips behind the support ring 16 at a throat 18 formed by the structured portion 15, so that the three components: seating face insert 11, sealing disk 12 and hydraulic fluid baffle insert 7 are secured in their relative axial position. A retaining ring 22 serves for securing the hydraulic fluid baffle insert 7 axially inside the housing cavity 6.

A hollow cylindrical control sleeve 8, the outside diameter of which is matched to the inside diameter of the hydraulic fluid baffle insert 7, is inserted into the cavity (not further denoted) of the hydraulic fluid baffle insert 7. For this purpose, the control sleeve 8 is accommodated by its housing shank-side end portion in an annular groove-shaped sleeve socket 21 formed by the structured portion 15 of the hydraulic fluid baffle insert 7 and is secured by the retaining ring 22 against axial displacement.

A control piston 9 embodied as a hollow piston having a piston cavity 33 is inserted into the cavity (not further denoted) of the control sleeve 8 so that it is axially displaceable. An annular control groove 24, which is delimited by axially spaced control portions in the form of a first annular flange 25 and a second annular flange 26, is sunk into the outer circumferential surface of the control piston 9. The outside diameter of the first and second annular flange 25, 26 is matched to the inside diameter of the control sleeve 8. On its housing shank-side end portion the second annular flange 26 of the control piston 9 forms an annular step 27, bearing against which is one end of a spring element 28, which at its other end is supported in a spring seat 23 formed by the structured portion 15 of the hydraulic fluid baffle insert 7. The control piston 9 is prevented from slipping out of the cavity of the control sleeve 8 under the spring force of the spring element 28 by the first annular flange 25, which comes to bear against the retaining ring 22.

The control piston 9 can be axially displaced inside the control sleeve 8 in opposition to the spring force of the spring element 28, for which purpose an actuator, for example a solenoid having a plunger, acts on the end face of the control piston 9 remote from the housing shank 4, as is described in the generic published patent application cited above.

In the area of the housing body 3 the valve housing 2 is provided with three axially spaced housing radial apertures 29-31, that is to say first housing radial apertures 29 formed on the side of the housing body 3 facing the housing shank 4, third housing radial apertures 31 formed on the side of the housing body 3 remote from the housing shank 4, and second housing radial apertures 30, which are arranged between these and which each open into the housing cavity 6. The hydraulic fluid baffle insert 7 is provided with first insert radial apertures 34 and second insert radial apertures 35, which each open into the cavity of the hydraulic fluid baffle insert. Similarly the control sleeve 8 is provided with first sleeve radial apertures 36 and second sleeve radial apertures 37, which each open into the cavity of the control sleeve 8. Here the second housing radial apertures 30, the first insert radial apertures 34 and the first sleeve radial apertures 36 are each arranged so that they radially align and open into one another. Equally, the third housing radial apertures 31, the second insert radial apertures 35 and the second sleeve radial apertures 37 are each arranged so that they radially align and open into one another. The housing cavity 6 of the valve housing 2 is provided with an axial housing cavity aperture 32, which is connected to an axial piston cavity aperture 38 of the piston cavity 33 of the control piston 9.

The first housing radial apertures 29 in the control valve 1 serve as hydraulic fluid inlet or hydraulic fluid connection (P) and are intended to be connected to a hydraulic fluid pump for delivering hydraulic fluid to the control valve 1. The second and third housing radial apertures 30, 31 each serve as working connection (A, B) for the connection to the pressure chambers of the camshaft adjuster, whereas the axial housing cavity aperture 32 serves as outlet connection (T) for the connection to a hydraulic fluid tank.

When hydraulic fluid flows through the first housing radial apertures 29 into the control valve 1, it reaches a central aperture 39 formed in the seating face insert 11, passes through the hydraulically openable check valve 13, passes into a hydraulic fluid compartment 40 formed by the structured portion 15 and is led to the control groove 24 of the control piston 9 via axial fluid ducts (not represented in more detail), which are formed or enclosed by the hydraulic fluid baffle insert 7. From the generic published German patent application cited above it will be known or obvious to the person skilled in the art how the hydraulic fluid baffle insert 7 is to be designed in order to form corresponding axial fluid ducts, so that there is no need here to go into further detail concerning this. The axial fluid ducts formed by the hydraulic fluid baffle insert 7 open into third sleeve radial apertures 41 of the control sleeve 8, which in turn open into the control groove 24.

Controlled by the control portions of the control piston 9 embodied in the form of annular flanges 25, 26, the second or third housing radial apertures 30, 31 (working connections) can be connected via the control groove 24 to the first housing radial apertures 29 (hydraulic fluid connection) according to the axial position of the control piston 9, while the respective other working connection is connected to the housing cavity aperture 32 (outlet connection). The control groove 24 therefore serves to establish a first hydraulic fluid line (fluid-conducting connection) between the first housing radial aperture 29 (inlet connection) and the second housing radial aperture 30 (first working connection ‘A’), the connection encompassing the central aperture 39, the hydraulic fluid compartment 40, the axial fluid ducts (not represented in further detail) of the hydraulic fluid baffle insert 7, the third sleeve radial aperture 41, the control groove 24, the first sleeve radial aperture 36 and the first insert radial aperture 34. The control groove 24 equally serves to establish a further first hydraulic fluid line (fluid-conducting connection) between the first housing radial aperture 29 (inlet connection) and the third housing radial aperture 31 (second working connection ‘B’), the connection encompassing the central aperture 39, the hydraulic fluid compartment 40, the axial fluid ducts (not represented in further detail) of the hydraulic fluid baffle insert 7, the third sleeve radial aperture 41, the control groove 24, the second sleeve radial aperture 37 and the second insert radial aperture 35. Controlled by the control piston, hydraulic fluid can be discharged from the first working connection 30 to the housing cavity aperture 32 (outlet connection ‘T’) via a second hydraulic fluid line, which encompasses the first insert radial aperture 34, the first sleeve radial aperture 36, the piston cavity 33 and the piston cavity aperture 38. Similarly, hydraulic fluid can be discharged from the second working connection 31 to the housing cavity aperture 32 (outlet connection ‘T’) via a further second hydraulic fluid line, which encompasses the second insert radial aperture 35, the second sleeve radial aperture 37, the piston cavity 33 and the piston cavity aperture 38.

The ring filter 10 serves to filter dirt particles carried by the hydraulic fluid, in order to prevent functional impairments of the control valve 1 and in particular the check valve 13 due to contamination.

As has already been described above, the check valve 13 comprises a sealing disk 12, which bears against an annular seating face 20 formed by the seating face element 19 of the seating face insert 11. The sealing disk 12 is pressed annularly against the seating face 20 by the end face of the support ring 16 of the structured portion 15, the retaining collar 17 securing it axially in position.

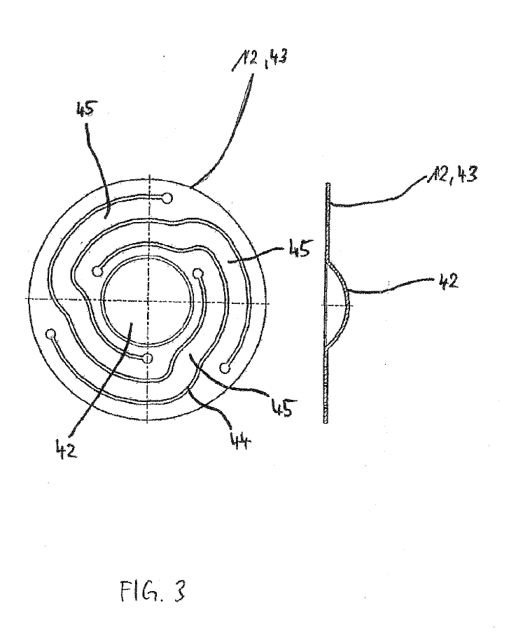

FIG. 3 represents the sealing disk 12 of the check valve 12 of the control valve 1 in more detail in a perspective view and an axial sectional view. Accordingly, the lamellar sealing disk 12 is composed of a cup-shaped disk center portion 42 and a plane disk outer portion 43. In the fitted state, the cup-shaped disk center portion 42 is situated inside the central aperture 39 of the seating face insert 11, while only the plane disk outer portion 43 bears against the seating face 20.

In the area of the disk outer portion 43, the sealing disk 12 is provided with a plurality of slit-shaped perforations 44, which, following a curvilinear path, each spirally surround the disk center portion 42. The disk outer portion 43 is thereby divided into a plurality of interconnected flexible tongues 45, which can each be bent elastically in an axial direction, widening the slit-shaped perforations 44. The spring force that has to be overcome in doing this depends on the material and thickness of the sealing disk 12, and on the arrangement and dimensions of the perforations 44.

For this purpose the sealing disk is made from spring steel with a thickness of 0.1 to 0.5 mm, for example. The slit width of the slit-shaped perforations is preferably at least 1 mm and is in the order of 1 to 2 mm, for example, in order to allow an adequate flow of hydraulic fluid.

In the fitted state the slit-shaped perforations 44 of the sealing disk 12 are situated outside the area of the central aperture 39. Under an incident flow of hydraulic fluid at a sufficient hydraulic opening pressure, the disk center portion 42 serving as sealing part for sealing the central aperture 39 is moved in relation to the fixed edge of the disk outer portion 43, the loose area of the disk outer portion 43 being lifted off the seating face 20 so that hydraulic fluid can flow through the widened perforations 44 and pass into the hydraulic fluid compartment 40. In the process, the disk center portion 42 is moved axially in relation to the fixed edge area of the disk outer portion 43, as the flexible tongues 45 are elastically deformed. Overstretching of the sealing disk 12 is prevented by a stop 46 formed by the structured portion 15 of the hydraulic fluid baffle insert 7.

In the event of a pressure surge occurring in the opposite direction or a return flow of hydraulic fluid, the sealing disk 12 bears against the seating face 20 with its disk outer portion 43 and the disk center portion 42 seals the central aperture 39, so that the check valve 13 blocks the return flow of hydraulic fluid.

The substantially smaller mass moment of inertia of the sealing disk 12 compared to a ball as closing element makes it possible to achieve an especially rapid closing of the check valve 13. Compared to a ball, moreover, the sealing disk 12 has a substantially larger effective incident flow area, so that the hydraulic closing pressure of the sealing disk 12 is greater than that of a ball, which assists the rapid closing.

The special design of the sealing disk 12 with spiral perforations 44 in the disk outer portion 43 affords the significant advantage that the flexible tongues 45 can be of relatively long design compared to the diameter of the sealing disk 12, so that the spring force is relatively low and a correspondingly low opening pressure is feasible.

Moreover, in practical trials for long-term service it has been shown that in a development of the sealing disk in which the central aperture 39 is sealed by a cap attached to the remaining part of the sealing disk by flexible tongues, a continuous load-bearing capacity of the sealing disk 12 is not sufficient for practical use.

The cup-shaped disk center portion 42 of the sealing disk 12 affords an advantageous incident flow behavior of hydraulic fluid against the sealing disk 12, since the disk center portion 42 is thereby uniformly displaced and the hydraulic force acts in the edge area of the disk center portion 42 adjoining the disk outer portion 43. Moreover, when the check valve 13 is closed, a self-centering of the sealing disk 12 can be advantageously achieved by the cup-shaped disk center portion 42 penetrating into the central aperture 39.

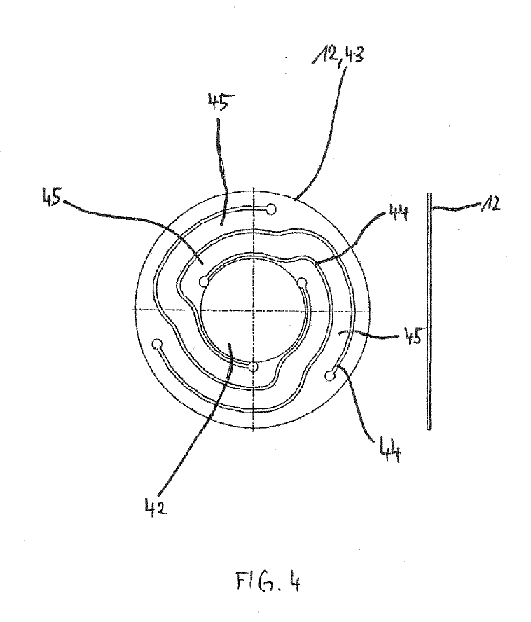

In FIG. 4 a further embodiment of the sealing disk 12 of the check valve 12 of the control valve 1 is represented in more detail in a perspective view and an axial sectional view. This embodiment of the sealing disk 12 differs from the embodiment shown in FIG. 3 merely in that the disk center portion 43 is not cup-shaped but is of plane form, so that the disk center portion 43 and the disk outer portion 44 together form a plane lamellar plate. In this embodiment, the advantages of the cup-shaped disk center portion 43 are dispensed with, but it facilitates manufacturing of the sealing disk 12.

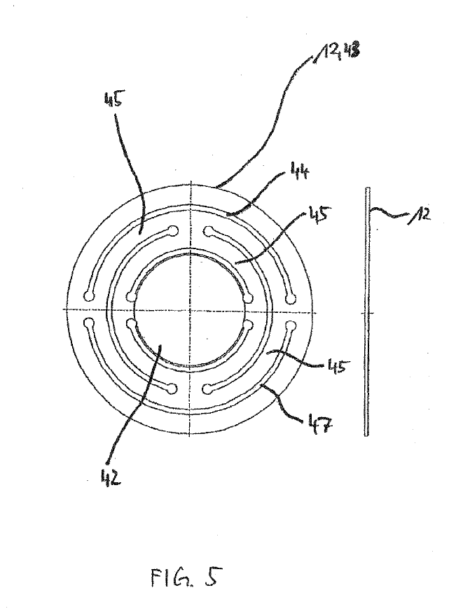

In FIG. 5, a further embodiment of the sealing disk 12 of the check valve 12 of the control valve 1 is represented in more detail in a perspective view and an axial sectional view. This embodiment of the sealing disk 12 differs from the embodiment shown in FIG. 4 merely in that the slit-shaped perforations 47 of the disk outer portion 43 do not surround the disk center portion 42 spirally but in the form of concentrically arranged annular elements, which allows particularly easy manufacture of the sealing disk 12.

Compared to the ball check valves conventionally used, the check valve 13 according to the invention therefore allows a substantially more rapid closing of the check valve due to the lower mass moment of inertia and the larger incident flow area. Since it allows an additional spring for impinging on the closing element to be dispensed with, savings in material and production costs are possible. The sealing disk 12 can easily be manufactured from an inexpensive material (for example spring steel) by punching the perforations 44, 47. Assembly in industrial mass production is especially easy, particularly in comparison with ball check valves. The special design of the sealing disk 12 with relatively long flexible tongues that can be displaced in opposition to a comparatively small spring force ensures reliable long-term service of the check valve.

### LIST OF REFERENCE NUMERALS

1 Control valve
2 Valve housing
3 Housing body
4 Housing shank
5 External thread
6 Housing cavity
7 Hydraulic fluid baffle insert
8 Control sleeve
9 Control piston
10 Ring filter
11 Seating face insert
12 Sealing disk
13 Check valve
14 Sleeve-shaped insert portion
15 Structured portion
16 Support ring
17 Retaining collar
18 Throat
19 Seating face element
20 Seating face
21 Sleeve socket
22 Retaining ring
23 Spring seat
24 Control groove
25 First annular flange
26 Second annular flange
27 Annular step
28 Spring element
29 First housing radial aperture
30 Second housing radial aperture
31 Third housing radial aperture
32 Housing cavity aperture
33 Piston cavity
34 First insert radial aperture
35 Second insert radial aperture
36 First sleeve radial aperture
37 Second sleeve radial aperture
38 Piston cavity aperture
39 Central aperture
40 Hydraulic fluid compartment
41 Third sleeve radial aperture
42 Disk center portion
43 Disk outer portion
44 Spiral perforation
45 Flexible tongue
46 Stop
47 Annular perforation

1. A control valve for controlling hydraulic fluid flows, comprising:
a hollow valve housing having at least one inlet connection, at least two working connections and at least one outlet connection;
a control piston, which is guided so that the control piston is axially displaceable inside the valve housing and which serves to connect the inlet connection to either working connection via at least a first hydraulic fluid line as a function of position, while the other working connection is connected to the outlet connection via at least a second hydraulic fluid line;
at least one hydraulically openable check valve opening the first hydraulic fluid line in an inlet direction and having a closing element, which serves for closing a valve aperture,
wherein the closing element is provided with at least one perforation, such that a sealing part, resiliently supported by at least one flexible tongue, is formed for sealing of the valve aperture.

2. The control valve of claim 1, wherein the closing element is formed from the sealing part and an outer part at least partially surrounding the sealing part, the outer part being provided with a plurality of perforations surrounding the sealing part in a spiral shape in order to form flexible tongues.

3. The control valve of claim 1, wherein the closing element is formed from the sealing part and an outer part at least partially surrounding the sealing part, the outer part being provided with a plurality of annular perforations concentrically surrounding the sealing part in order to form flexible tongues.

4. The control valve of claim 1, wherein the closing element is of disk-shaped design.

5. The control valve of claim 2, the wherein at least one of the perforations is of slit-shaped design and has a minimum slit width of at least 1 mm.

6. The control valve of claim 5, wherein the at least one of the perforations has a minimum slit width in the order of 1 to 2 mm.

7. The control valve of claim 1, wherein the closing element is composed of spring steel.

8. The control valve of claim 7, wherein the spring steel has a thickness in the order of 0.1 to 0.5 mm.

9. The control valve as of claim 1, wherein a hollow hydraulic fluid baffle insert having a hydraulic fluid duct for a fluid-conducting connection of the inlet connection to a control groove of the control piston and accommodating the control piston so that the control piston is axially displaceable in a hollow cavity thereof, is arranged inside the valve housing, the hydraulic fluid baffle insert being provided with a structured portion for fixing the closing element to a seating face.

10. The control valve of claim 9, wherein the seating face is formed by a seating face insert inserted into housing cavity.

11. The control valve of claim 10, wherein the seating face insert is provided with a retaining element for the relative axial fixing of the hydraulic fluid baffle insert.

12. The control valve as of claim 9, wherein the hydraulic fluid baffle insert forms a stop for the closing element situated in an open position.

13. A camshaft adjuster comprising a control valve as claimed in claim 1.

14. The control valve of claim 3, wherein at least one of the perforations is of slit-shaped design and has a minimum slit width of at least 1 mm.

15. The control valve of claim 14, wherein the at least one of the perforations has a minimum slit width in the order of 1 to 2 mm.
